(19) United States
(12) Patent Application Publication
(10) Pub. No.: US 2013/0006471 A1
(43) Pub. Date: Jan. 3, 2013

(54) METHOD AND ARRANGEMENT FOR REGULATING A CONTROLLABLE ENERGY ABSORBER

(75) Inventor: Helmut Kirmsze, Schaan (LI)

(73) Assignee: Thyssen Krupp Presta AG, Eschen ,Liechtenstein (LI)

(21) Appl. No.: 13/634,745

(22) PCT Filed: Apr. 1, 2011
(86) PCT No.: PCT/EP2011/001647

§ 371 Date: Sep. 13, 2012

(30) Foreign Application Priority Data
May 10, 2010 (DE) 10 2010 020 088.3

(51) Int. Cl. B62D 1/19; G06F 7/00

(52) U.S. Cl. 701/36

(57) ABSTRACT

The invention relates to a method of regulating a controllable energy absorber in a steering system for a motor vehicle, having the following steps:
determination of a parameter (selected from travel vs. time, speed, and acceleration) of a relative movement between a bracket unit intended for fixing to the motor vehicle to be solidly secured thereto and a steering shaft mounting unit, held by the bracket unit, for the mounting of a steering shaft in such a way as to be rotatable, the steering shaft mounting unit being displaceable relative to the bracket unit along a travel in displacement within a limited interval,
output of a control signal to a controllable energy absorber for the setting of a resisting force against a displacement of the steering shaft mounting unit relative to the bracket unit.

The present invention relates to a method of regulating a controllable energy absorber in a steering system for a motor vehicle, having the following steps:
determination of a parameter of a relative movement between a bracket unit intended for fixing to the motor vehicle to be solidly secured thereto and a steering shaft mounting unit, held by the bracket unit, for the mounting of a steering shaft in such a way as to be rotatable, the steering shaft mounting unit being displaceable relative to the bracket unit along a travel in displacement within a limited interval,
output of a control signal to a controllable energy absorber for the setting of a resisting force against a displacement of the steering shaft mounting unit relative to the bracket unit.

The invention also relates to an arrangement for regulating a controllable energy absorber in a steering system for a motor vehicle, having a bracket unit intended for fixing to the motor vehicle to be solidly secured thereto and having a steering shaft mounting unit, held by the bracket unit, for the mounting of a steering shaft in such a way as to be rotatable, the steering shaft mounting unit being displaceable relative to the bracket unit along a travel in displacement within a limited interval, the energy absorber being suitable for applying a resisting force against a displacement of the steering shaft mounting unit relative to the bracket unit, the energy absorber being able to be set to various resisting forces by a control signal.

DE 60110870 T2 discloses a method of operating a controllable energy absorber in which at least one sensor for sensing the driving situation senses information which is related to the order of magnitude of the energy in a secondary collision and comprises a weight sensor, a vehicle-speed sensor, a passenger-position sensor and a sensor for sensing whether safety-belts are being worn, and a collision sensing sensor, on the basis of which the energy absorbing capacity of a controllable energy absorber is set. The method disclosed thus requires a large number of sensors and is costly and complicated to implement. What is more, it is not possible to achieve an optimum match to the crash process which actually takes place.

Disclosed in GB 2435551 B is a method of operating a controllable energy absorber in which the energy absorbing capacity is controlled on the basis of driver height, driver weight, vehicle speed and vehicle attitude. As well as a large number of measured variables being used, which makes for commensurate cost and complication, no instruction is given as to how the controllable energy absorber is to be operated in a suitable way on the basis of these measured variables.

EP 1632418 A2 discloses a method of operating a controllable energy absorber in which a match is made to the tilt position at which the steering column is set. However, there is no matching of the curve followed by force to the parameters which actually exist in the event of a crash, such as the height of the driver, the weight of the driver and the speed of the vehicle immediately before the crash event occurs.

The object of the invention is to provide a method of regulating a controllable energy absorber which sets the energy absorbing capacity of a controllable energy absorber as reliably as possible, with little cost or complication as far as measuring equipment and computing work are concerned, in order to keep any injury to the driver to as low a level as possible.

The object of the invention is also to provide an arrangement by which, in the event of a crash, the energy absorption of the steering column can be operated or regulated in such a way that the driver suffers as little injury as possible.

This object is achieved by a method according to claim 1 or 6.

The object is also achieved by an arrangement according to claim 12.

Advantageous refinements of the invention are described in the dependent claims.

In particular, for a steering system having a sensor for determining a position (s) of the steering shaft mounting unit (3) along the travel in displacement, the method comprises the following steps:
measurement of the instantaneous position (si) of the steering shaft mounting unit (3), continuously or at presettable points in time (ti), or determination of the elapsed time (ti) at presettable positions (si);
calculation of the instantaneous speed (vi) of displacement of the steering shaft mounting unit (3);
determination of a preset value for the value of the control signal for output to the energy absorber, on the basis of the instantaneous position (si) and the instantaneous speed (vi) at which the instantaneous displacement is taking place;
output of the control signal to the energy absorber.
In an alternative method, the steps for which provision is made are as follows:
measurement of the instantaneous position (si) of the steering shaft mounting unit (3), continuously or at presettable preset times (tVi), or determination of the elapsed time (ti) until presettable preset positions (sVi) are reached;
calculation of an instantaneous value for the desired difference in the form of a difference between an instantaneous position (si) less the preset position (sVi), or of an instantaneous value for the desired difference given by the preset time (tVi) less the elapsed time (ti);
determination of a preset value for the value of the control signal for output to the energy absorber, on the basis of the instantaneous position (si) and the instantaneous speed (vi) at which the instantaneous displacement is taking place;
output of the control signal to the energy absorber. The controllable energy absorber is so designed in this case that the speed-dependent resisting force against a displacement of the steering shaft mounting unit relative to the bracket unit solidly secured to the bodywork can be altered as a result of the actuation of the energy absorber by the control signal.

The idea on which the invention is based is that the driver has a given kinetic energy when he impacts on the steering wheel in the event of a crash. This kinetic energy is absorbed by the resisting force which the steering wheel, or rather the steering shaft mounting unit which is connected to the steering wheel, sets up to oppose the displacement relative to the bracket unit. The absorption of the energy takes place in this case over the travel in displacement, the limits of which are set by a suitable interval. To keep any injury to the driver to a minimum, the resisting force must be kept to a minimum throughout the whole of the crash. However, it must be borne in mind that a force peak, which would then result in injury to the driver, must not occur at the end of the travel in displacement.

The kinetic energy which the driver has to dissipate via the steering column in the event of an accident or crash depends on various circumstances such for example as: whether or not the driver is wearing a seat belt, whether or not there is a belt pretensioner, what seated position the driver is in, how tall the driver is, what the driver weighs, and a large number of other parameters. The main aim of the invention is therefore for the energy absorbing behaviour of the steering column to be optimum when the energy transmitted by the driver to the steering column is absorbed by precisely that resisting force which results in this kinetic energy being completely absorbed at the end of the travel in displacement (i.e. within the interval). What is used as a measure of the energy transmitted is the parameter of the relative movement between the steering shaft mounting unit and the bracket unit. The parameters from which a choice can be made in this case are travel vs. time, speed and acceleration.

For a representation of optimised energy absorption of this kind to be obtained, a large number of measurements had to be made and calculating steps carried out in the prior art to determine the kinetic energy transmitted by the driver to the steering wheel and to determine therefrom the optimum signals for actuating the energy absorber. In particular, the conditions governing how the actuation of the energy absorber actually affects the absorption of energy are often unclear and are hardly predictable in the event of a crash. It should be borne in mind in this connection that the intention is that a crash event should never in fact occur. It is therefore possible that the crash may not occur until many years have passed and the tribological conditions have been changed by environmental factors (corrosion).

The essence of the invention is therefore that optimised energy absorption is made possible with only a very few measurements, with a large number of the circumstances and measured values detailed above being replaced by one easily measurable replacement parameter. What is used as a replacement parameter is the travel in displacement of the steering shaft mounting unit relative to the bracket unit, as a function of time.

In a preferred embodiment, there is positioned for the purpose of measuring travel, on one of the two components which are moved relative to one another, a travel sensor which scans fixed travel markings which are arranged on the other of the components which are moved relative to one another. A particular preference is for a Hall-effect sensor as a travel sensor. The distances between the travel markings may be equal or progressive. The travel markings are to be so arranged in this case that, in the event of a displacement caused by a crash, one or more position signals and best of all three signals become available as soon as possible together with their associated points in time. With a known resisting force, the energy applied can then be determined from them mathematically. In practice however the resisting force is only known in a very inexact way, if at all. Therefore, what is first proposed by the invention is that a corrected control signal be calculated from the instantaneous speed of the displacement. The more complicated and more exact procedure in this case is to determine, at the various points in time or the various positions of the displacement and on the basis of the instantaneous speed and the change in speed (acceleration), whether the resisting force is sufficient to reduce the speed to zero by the end of the interval. If the speed calculated for the end of the interval is greater than zero, or less than a preset value, the resisting force is increased. If the speed calculated for the end of the interval will already have reached a value of zero before the end of the interval, the resisting force is reduced, to obtain energy absorption at as low a level of force as is possible.

In a preferred embodiment, the change in speed relative to the speeds calculated immediately before is used to determine the speed calculated for the end of the interval.

This being the case, it is preferred that the preset value calculated in the given case for the control signal be altered in the direction of a higher resisting force if the speed most recently determined (vi) is equal to or greater than the speed determined immediately before it (vi-1).

A further improvement in the method ensues from the preset value calculated in the given case for the control signal being altered in the direction of a lower resisting force if the speed most recently determined (vi) is so much lower than the speed determined immediately before it (vi-1) that, if the change in speed continues to be constant, the speed (vx) will reach a value of zero before the limit (se) of the interval of travel in displacement is reached.

In this variant of the invention, a preferred embodiment is one where the preset value calculated in the given case for the control signal is altered in the direction of a higher resisting force if a group of most recently determined values of speed (vi, vi-1) are equal to or greater than the group of values of speed determined immediately before them (vi-1, vi-2).

A further improvement to this variant of the invention is made if the preset value calculated in the given case for the control signal is altered in the direction of a lower resisting force if the group of most recently determined values of speed (vi, vi-1) are so much lower than the group of speeds determined immediately before them (vi-1, vi-2) that, if the change in speed continues to be constant, the speed (vx) will reach a value of zero before the limit of the interval of travel in displacement is reached.

As a simplification, it is proposed by the invention that the calculation of the speed expected at the end of the interval be replaced by a table which gives preset speeds for each of the preset points in time or each of the preset positions, at which a measurement is made. The resisting force can therefore be raised if the instantaneous speed measured in any given case exceeds the preset speed. A reduction in the resisting force can be made if the preset speed is not reached. The raising or reduction of the resisting force takes place as a result of an appropriate calculation of the preset value for the control signal and its output to the control system. It is advantageous for a plurality of sets of preset speeds of this kind to be provided, with the values of the first three instantaneous speeds measured determining which set is selected for the continuing regulation.

In a further simplification, it is proposed by the invention that the calculation of the instantaneous speeds be dispensed with completely and only the positions as a function of the points in time be determined and compared with preset values. It is possible in this case for the elapsed time until each of the positions preset in the given case is reached to be determined and compared with a preset time. This variant is particularly easy to implement in technical terms. With the help of fixed travel markings and a sensor directed at them, the value with the appropriate subscript i can be read out from the table simply by counting down and the comparison can be performed in this way. Alternatively, in a process which can be considered mathematically equivalent, the positions, i.e. the distances covered in each case in the displacement, can be determined at fixed preset points in time. However, in this case the measurement of travel required is slightly more complicated because it has to be possible for the travel to be measured virtually continuously. Mathematically, all that has to be borne in mind as the difference between the two alternatives is that longer elapsed times measured at defined positions correlate with slower speeds and the resisting force has to be lowered in the appropriate way, whereas longer distances of travel covered which are measured at fixed preset points in time correlate with higher speeds and the resisting force has to be raised in the appropriate way.

In this case too, it is advantageous for a plurality of sets of tables to be provided which give the preset times, or alternatively which give the distances covered in travel or the positions. It is advantageous for the table to be used in the given case to be determined from the first and/or second elapsed times which are measured until the first and/or second preset positions are reached. The same applies mutatis mutandis to a table giving preset positions.

With advantage, the matching of the resisting force and hence of the control signal is performed by means of a proportionality factor k which, as a further preference, is dependent on the distance covered in travel. In the simplest case, the change in the proportionality factor is likewise made in proportion to the distance covered in travel.

The triggering of the regulating process can easily be performed by means of a detecting system present in the vehicle for detecting a crash (=an impact of the vehicle against an obstacle). It is also conceivable and possible for the triggering to be controlled by means of the air-bag control system.

In a refinement of the invention it is also conceivable and possible for it be concluded that a crash is happening and for the regulating procedures to be started simply from the occurrence of high speeds of displacement of the steering shaft mounting unit relative to the bracket unit. However, for this purpose the means of measuring position must be active at all times.

Further features and details of preferred embodiments of the invention will be explained by reference to the accompanying drawings. In the drawings:

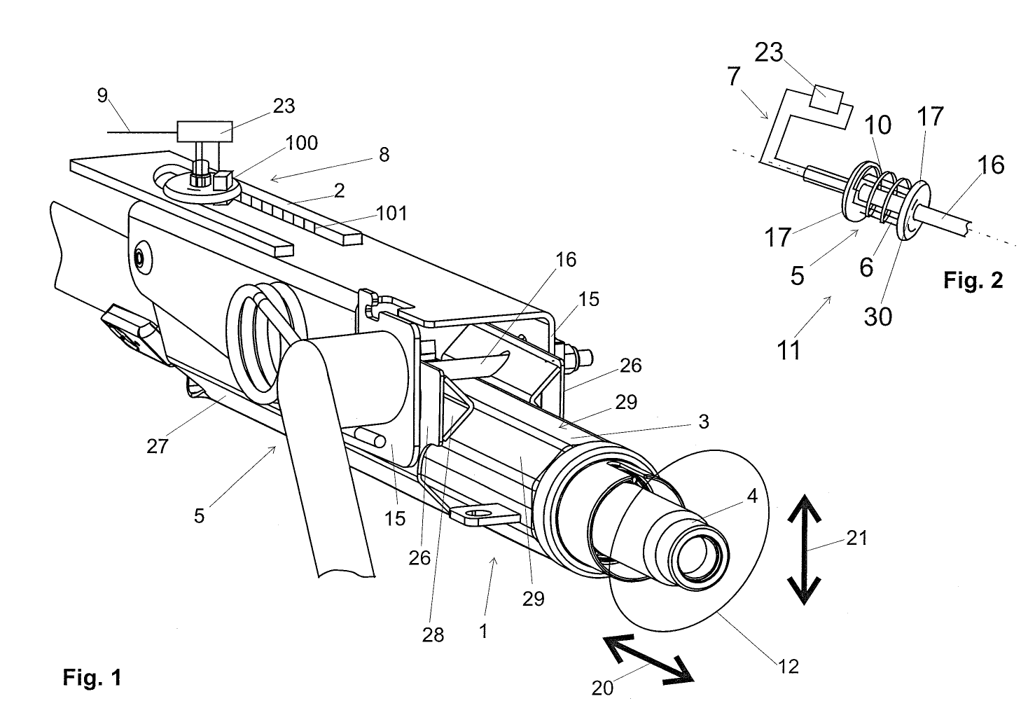

FIG. 1 is a view of a first exemplary embodiment of the invention.

FIG. 2 is a view of a clamping element of an energy absorber suitable for the invention where the latter is arranged as a clamping drum.

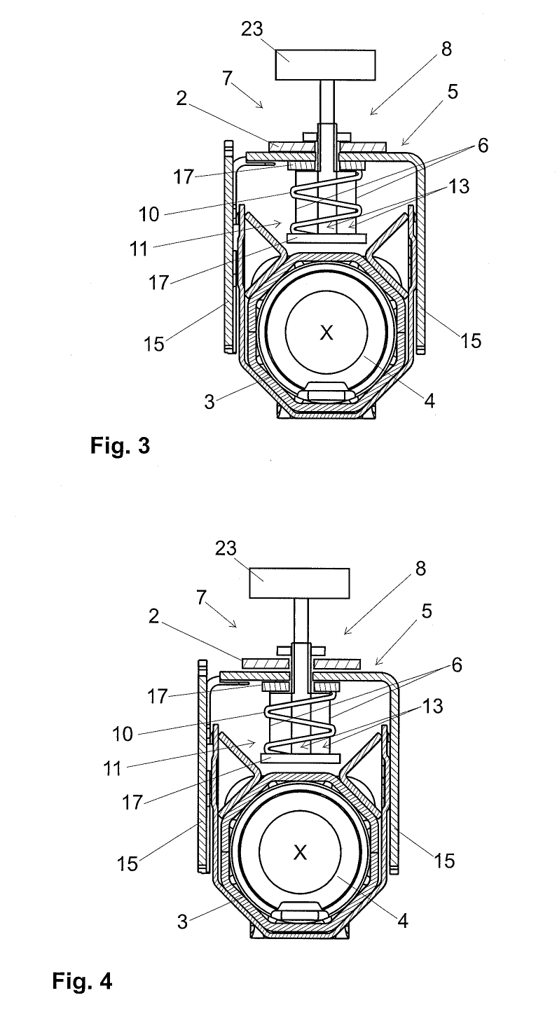

FIG. 3 is a view of the first exemplary embodiment of the invention in cross-section in a first position.

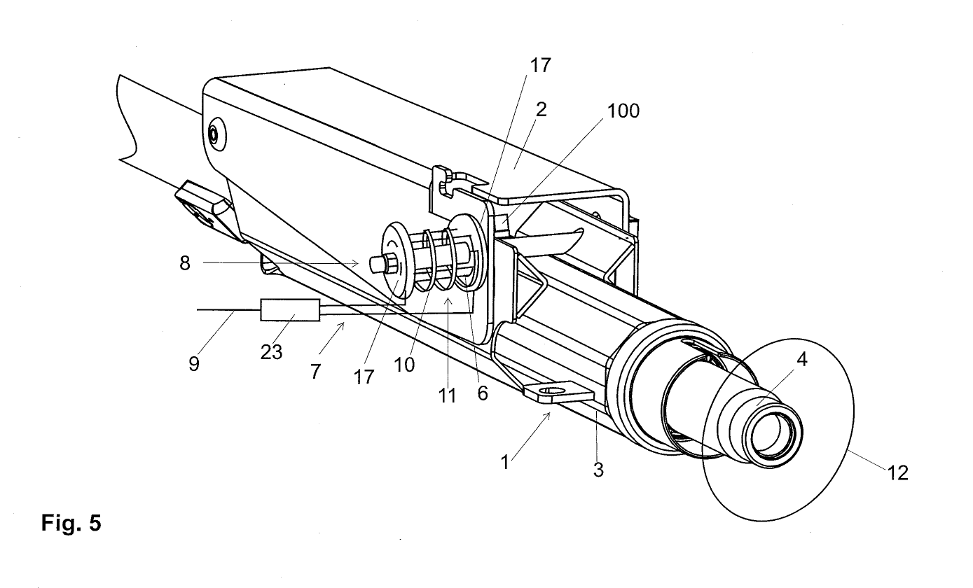

FIG. 4 is a view of the first exemplary embodiment of the invention in cross-section in a second position.

FIG. 5 is a view of a second exemplary embodiment of the invention.

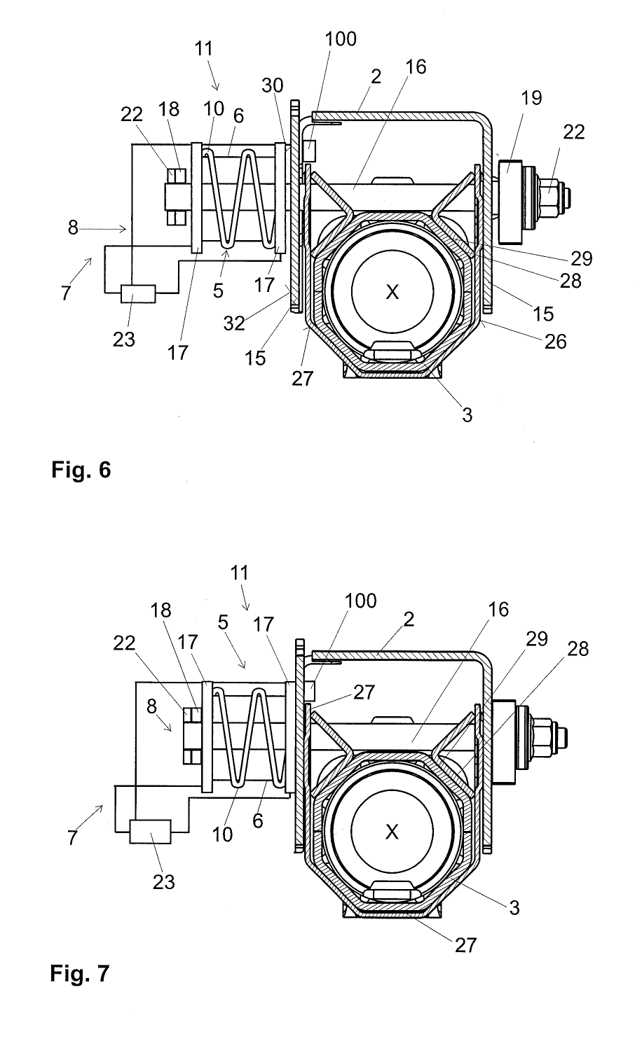

FIG. 6 is a view of a second exemplary embodiment of the invention in cross-section in a first position.

FIG. 7 is a view of the second exemplary embodiment of the invention in cross-section in a second position.

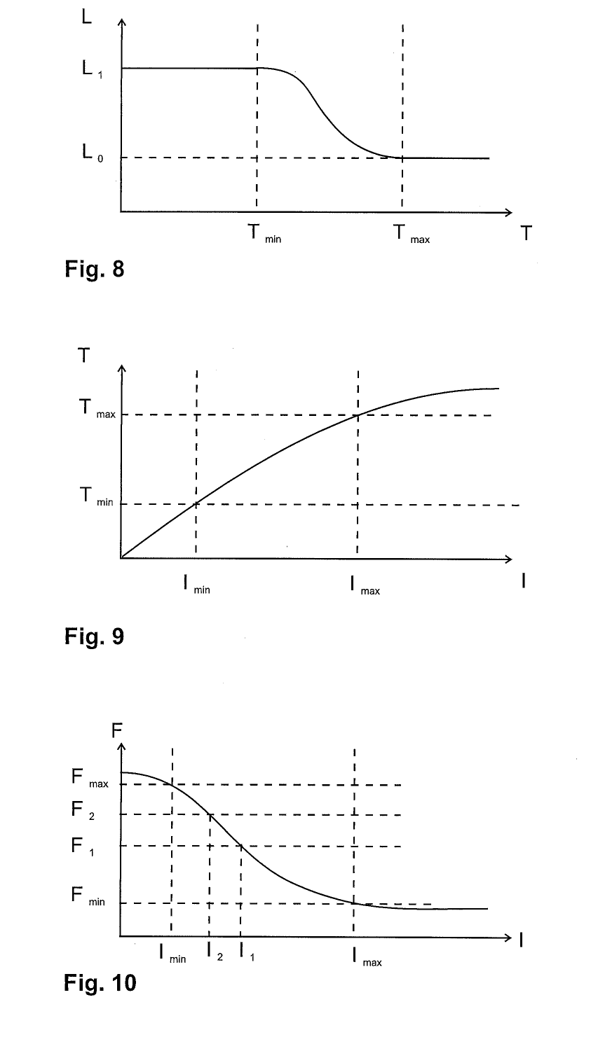

FIG. 8 is a graph of the length of the wire controlling the change in the resisting force, as a function of the temperature of the deformable member.

FIG. 9 shows the temperature of the wire as a function of the current flowing through the deformable member.

FIG. 10 shows the force displacing the steering shaft mounting unit relative to the bracket unit as a function of the current flowing through the wire.

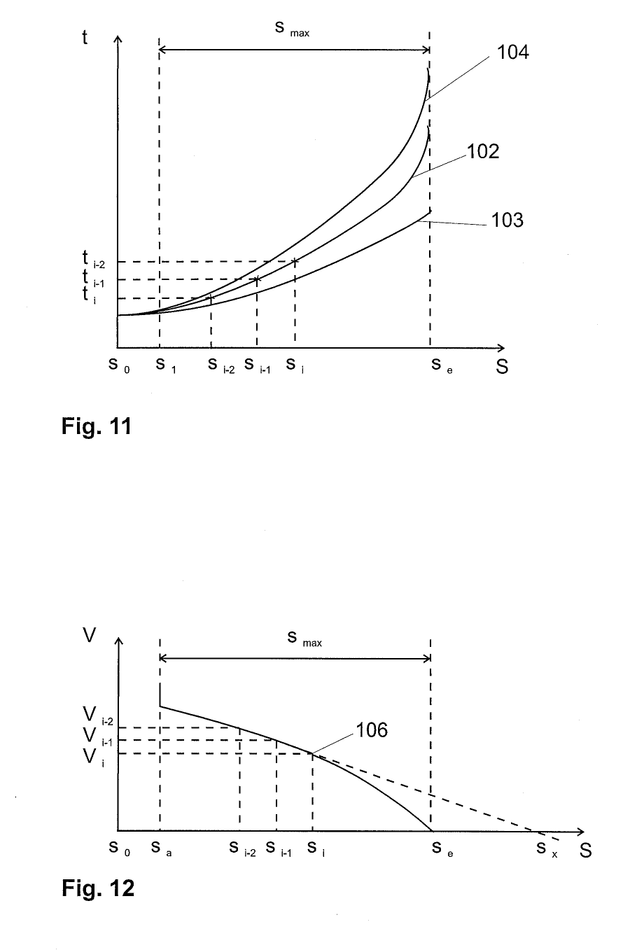

FIG. 11 shows examples of a curve for travel vs. time in the event of a crash.

FIG. 12 shows an example of a curve for travel vs. speed when the initial speed is too low.

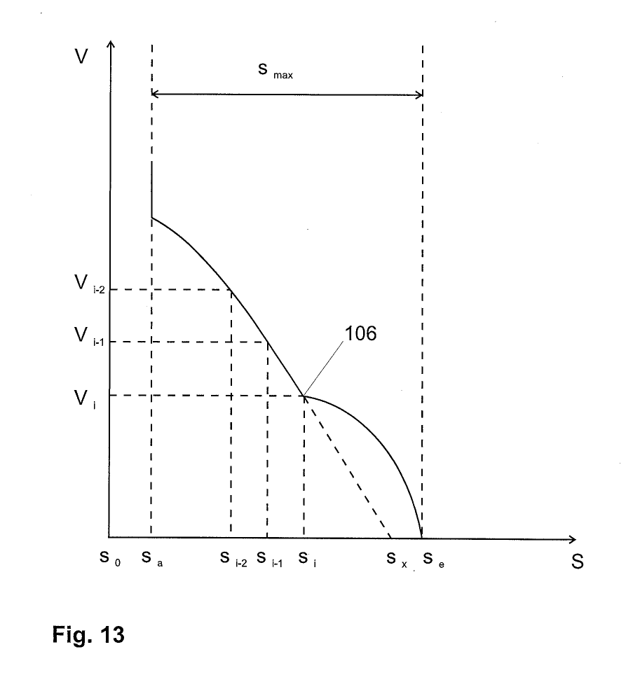

FIG. 13 shows an example of a curve for travel vs. speed when the initial speed is too high.

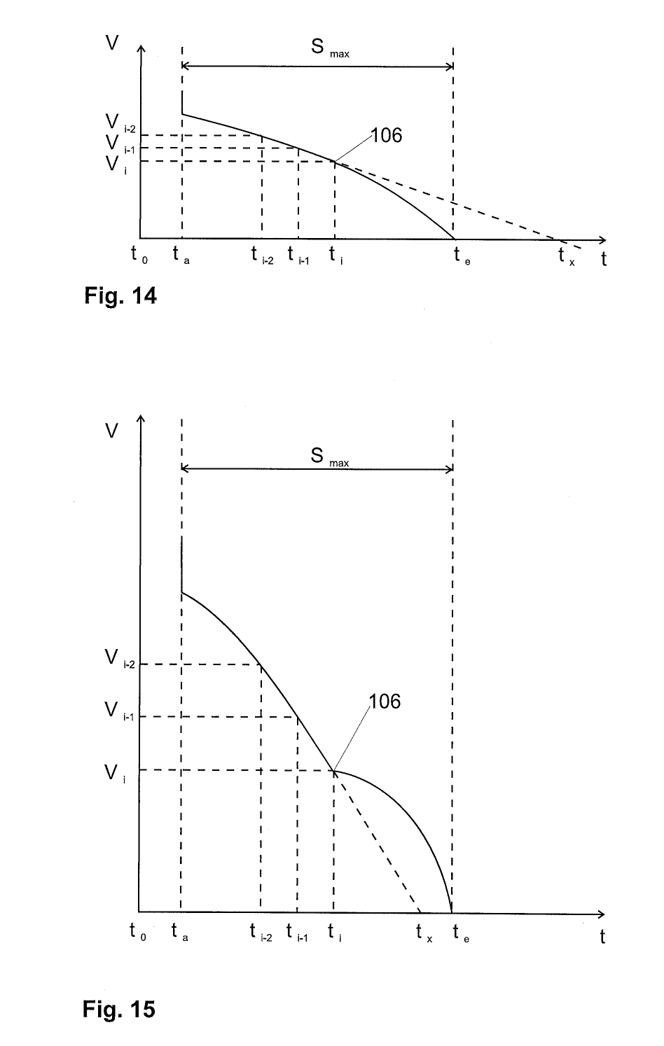

FIG. 14 shows an example of a curve for speed vs. time when the initial speed is too low.

FIG. 15 shows an example of a curve for speed vs. time when the initial speed is too high.

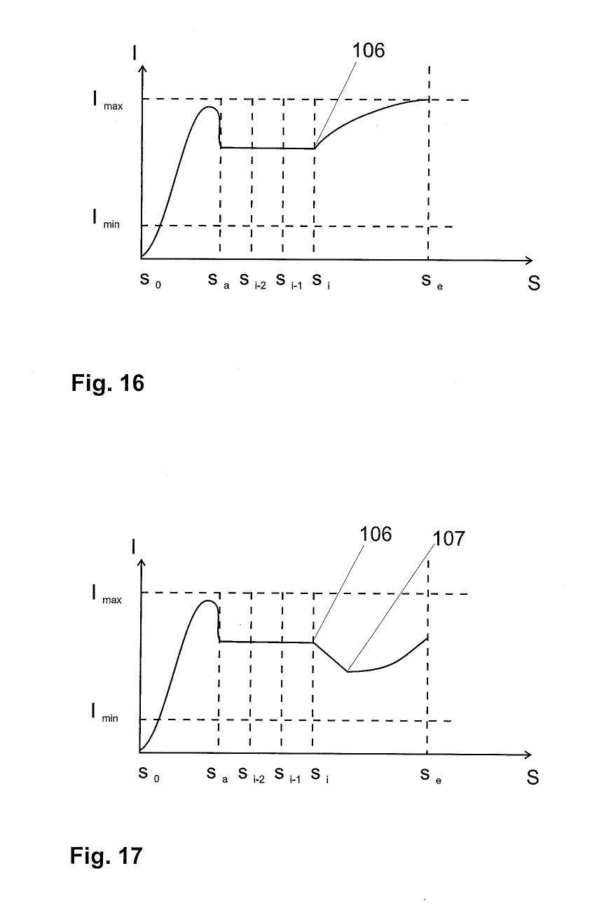

FIG. 16 shows a graph for control current as function of the positions of the steering shaft mounting unit in the event of a crash, where the resisting force is too high at the beginning of the crash.

FIG. 17 shows a graph for control current as function of the positions of the steering shaft mounting unit in the event of a crash, where the resisting force is too low at the beginning of the crash.

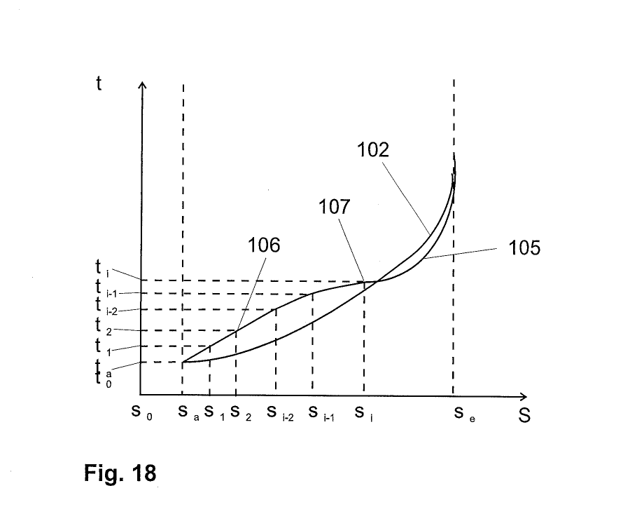

FIG. 18 is a graph of travel vs. time in a crash process.

Elements which are of the same kind or which act in the same way are referred to by the same reference numerals, as they also are in the other drawings.

Shown in FIGS. 1, 3 and 4 is a first exemplary embodiment of arrangement according to the invention.

FIG. 1 is a perspective view of the steering column 1. FIGS. 3 and 4 are vertical sections taken in the region of the energy absorber 8. The basic construction of the steering column 1 is that of one of the many examples of the form which an adjustable steering column of this kind can take which are known per se in the prior art. In the example shown, the steering shaft 4 to which the steering wheel 12 is fastened is held in the steering shaft mounting unit 3 in such a way as to be rotatable. The steering shaft mounting unit 3 is adjustable relative to the bracket unit 2 together with the steering shaft 4. In the first exemplary embodiment, provision is made both for an adjustment parallel to the longitudinal direction 20 of the steering shaft 4, i.e. an adjustment of length, and for an adjustment in a direction 21 at right angles to the longitudinal direction of the direction of the steering shaft 4, i.e. an adjustment of rake. In the example shown, the steering shaft mounting unit 3 is mounted for this purpose between side sections 15 of the bracket unit 2, as is known per se. The said adjustments in the longitudinal direction 20 and in the rake direction 21 can be performed by means of appropriate slotted holes or the like such as are known in the prior art. In this embodiment, a fixing arrangement 5 and an energy absorber 8 are provided. In its closed position, the fixing arrangement 5 holds the steering shaft mounting unit 3 in a fixed position relative to the bracket unit 2, which latter is solidly secured to the vehicle. The fixing is performed in this case by a frictional or positively interengaged connection. In the event of the fixing being by friction, the connection is made between the side sections 15 of the bracket unit 2 and side-faces 26 of a pivoting lever 27 and between side-faces 28 of the pivoting lever 27 and side-faces 29 of the steering shaft mounting unit 3. In the event of the fixing being by positive interengagement, the connection is made in the usual way by means of sets of teeth (not shown) which are brought into engagement. The fixing is performed by means of the fixing arrangement 5, whose side-face is pressed against the side-face of the side section 15 in the closed position. When the fixing arrangement 5 is in the open position, the desired adjustment of the steering shaft mounting unit 3 can be made relative to the bracket unit 2 solidly secured to the vehicle. The position of the steering shaft mounting unit 3 relative to the bracket unit 2 is then fixed again by changing the fixing arrangement over to the closed position. At least when the vehicle is moving, the position set should be the closed one. The bracket unit 2 can be fitted to the vehicle and thus fixed in place by means of suitable straps (not shown) such as are known in the prior art.

In the exemplary embodiments, the drive for the energy absorber 8 takes the drum-like form of a clamping drum 11 (see FIG. 2). This has two plates 17 arranged opposite one another. Extending between these plates 17 is a deformable member which is looped back and forth a number of times and which, in the exemplary embodiments, takes the form of a wire 6. In the exemplary embodiment shown, the wire 6 is made of a shape member alloy which shortens or contracts as a result of being heated. Arranged in addition between the plates 17 is an elastic return member 10 which in the present case takes the form of a coil spring. The two plates 17 are moved towards one another by means of the wire 6 when the wire 6 is suitably heated. The distance between the plates 17 thus becomes shorter. The return member 10 opposes this shortening and presses the plates 17 apart again in a direction parallel to the longitudinal direction of the clamping pin 16 when the wire 6 is or rather has been cooled again in the appropriate way, whereby the second position is again reached. The clamping drum 11 can be positioned at a suitable point by means of an attaching pin and via the side-face 30 it is able to apply a clamping force to suitably located sections of surface. By means of the actuating system, this clamping force and a frictional force which acts in a corresponding way in the event of a displacement can be varied.

In the event of the driver impacting on the steering column (in a crash), the desired displacing force which is intended to cause energy absorption is set by the energy absorber 8. For this purpose, the control system 23 receives a crash signal 9 and if required supplies current to the wire 6 of the clamping drum 11. As a result a corresponding clamping force is applied to the frictional connection between the bracket 2 and a component connected to the steering shaft mounting unit 3. This results in the resisting force against the displacement of the steering shaft mounting unit 3 relative to the bracket unit 2 being at a defined level.

As will also be explained by reference to the other exemplary embodiments, this resisting force can be varied even during the crash process by a suitably set current supplied to the wire 6, thus making it possible for the energy absorption to be accurately matched to what happens in the course of the crash.

By way of example, a possible first position is shown in FIG. 3 and a possible second position in FIG. 4. Because it is difficult to represent levels of force, what has been selected as an expedient to represent them is the distance between the surfaces in frictional contact. What is represented in FIG. 3, in which it is advantageous for no current to be supplied to the wire 6, is a higher level of force such for example as an upper limit Fmax for the resisting force against the displacement of the steering shaft mounting unit 3 relative to the bracket unit 2. The surfaces in frictional contact press against one another with a high force and if there is any displacement a commensurately high frictional force comes into play.

If a maximum current Imax is supplied to the wire 6, heating takes place to the upper limiting temperature Tmax and, as in the example, the wire 6 shortens. This makes the distance between the plates 11 shorter, and the surfaces in frictional contact are thus pressed against one another with only a low force. This represents a lower limit Fmin for the resisting force against the displacement of the steering shaft mounting unit 3 relative to the bracket unit 2. It is even conceivable and possible for a small clearance to be set between the surfaces in frictional contact, as in shown in an exaggerated form in FIG. 3 to represent the lower force.

By supplying intermediate values of current between Imax and zero it is even possible to set intermediate values of the pressing force and of the frictional force which goes hand in hand with it.

The steering column also comprises a sensor 100 which scans a set of markings 101. In the example this is a Hall-effect sensor which scans a set of ribs or a set of teeth which is arranged on the side of the slotted hole within which the displacement can take place.

The levels of the currents and forces and the like will be explained by reference to the other exemplary embodiments.

The second exemplary embodiment is shown in FIGS. 5 to 7. It is very similar to the first exemplary embodiment except that the energy absorber 8 is built into the fixing arrangement 5 or in other words the two arrangements form a single arrangement. FIG. 5 is a perspective view of the steering column 1. FIGS. 6 and 7 are vertical sections taken in the region of the energy absorber 8. This is the basic structure which has already been explained by reference to the first exemplary embodiment. In the present embodiment, the fixing arrangement 5 and the energy absorber 8 take the form of a single combined arrangement. In the closed position, the energy absorber 8 holds the steering shaft mounting unit 3 in a fixed position relative to the bracket unit 2 which is solidly secured to the vehicle. The fixing takes place in this case by means of the frictional connection between the side sections 15 of the bracket unit 2 and side faces 26 of a pivoting lever 27 and between side faces 28 of the pivoting lever 27 and side faces 29 of the steering shaft mounting unit 3. The fixing is accomplished by means of the energy absorber 8, whose side face 30 is pressed against the side face 32 of the side section 15 in the first position. The first position should correspond to the upper limit on force Fmax in this case. When the energy absorber 8 is in the second position, the desired adjustment of the steering shaft mounting unit 3 relative to the bracket unit 2 solidly secured to the vehicle is able to take place. The second position should therefore correspond to the lower limit on force Fmin, which needs of course to be appropriately low.

The position of the steering shaft mounting unit 3 relative to the bracket unit 2 is then fixed again by transferring the energy absorber to the first position. At least when the vehicle is moving, the position set should be the first one. The bracket unit 2 can be fitted to the vehicle and thus solidly secured in place by means of suitable straps (not shown) such as are known in the prior art.

In the second exemplary embodiment, the basic structure has a clamping pin 16 which passes through the side sections 15. Fastened to the ends of the clamping pin 16 by means of screws 22 are the stop 18 and the abutment 19. The clamping arrangement 11 designed in accordance with the invention is situated on the left-hand side between the stop 18 and the side section 15 of the bracket unit 2. In the first position, the pressure-applying surface 30 and, as a consequence, the abutment 19 too are pressed against the side sections 15 of the bracket unit 2, as a result of which the steering shaft mounting unit 3 is guided between the side sections 15 in frictional engagement therewith.

The sensor 100 scans an edge (not shown) and the measurement of position thus becomes possible.

FIG. 6 shows the second position of the energy absorber in which the steering shaft mounting unit 3 is adjustable relative to the bracket unit 2 in direction 20 and/or 21. In this state, the control system 23 feeds a maximum current Imax to the heating arrangement 7. When this current flows, the shape memory alloy heats to above the upper limiting temperature Tmax as a result of its ohmic resistance, and the desired shortening of the wire to a length L0 thus takes place. As a result of this, the plates 17 are moved towards one another in opposition to the resilient force from the return member 10. As shown in FIG. 6, this relaxes the energy absorber and the steering shaft mounting unit 3 is thus no longer held clamped between the side sections 15. The resisting force against the displacement of the steering shaft mounting unit 3 thus drops below the level of the lower limiting force Fmin for which the energy absorber was designed when the steering column was being designed (see FIGS. 13-15). FIG. 7 shows the energy absorber in the state where no current is supplied, in which it is in a first position in which the position of the steering shaft mounting unit 3 relative to the bracket unit 2 is fixed. The control system 23 does not feed any current through the wire 6 and the latter thus does not heat up. In the situation shown in FIG. 4, the temperature of the wire 6 is below the limiting temperature Tmin and the return member 10 is thus able to press the plates 17 apart. As in the first exemplary embodiment, the side sections and the corresponding pairs of faces 30, 32, 26, 27, 28, 29 and the side sections 15 are thus pressed against one another by means of the clamping pin 16, whereby the steering shaft mounting unit 3 is fixed in position by clamping. The resisting force against the displacement of the steering shaft mounting unit 3 thus exceeds the level of the upper limiting force Fmax for which the energy absorber was designed when the steering column was being designed (see FIGS. 13-15).

To enable the switching process when the energy absorber is being changed over from the second position shown in FIG. 6 to the first position shown in FIG. 7 to take place as quickly as possible, a cooling arrangement may be provided as well as the heating arrangement 7. This may for example take the form of a fan or blower.

As shown in the examples, the supply of current to the wire may take place in a variety of ways. What is shown in the exemplary embodiments, in FIGS. 2, 3, 6 and 7 for example, is that current is supplied to the wire as a result of contact being made between the control system 23 and the two ends of the wire. In this case it is necessary for the ends of the loops of wire, which may also take the form of pulleys carrying the ends of the loops, to be designed to be insulated against the flow of current. Alternatively, the supply of current may, in all the exemplary embodiments, take place via the plates 17 and/or the ends of the loops and/or the pulleys carrying the ends of the loops, as is shown for example in FIG. 8. In this version, contact is therefore made between the control system 23 and the plates 17 and/or the ends of the loops and/or the pulleys carrying the ends of the loops.

FIGS. 8, 9 and 10 show, by way of example, how an appropriate change in the length of the wire 6 and a change resulting therefrom in the resisting force against a displacement of the steering shaft mounting unit relative to the bracket unit can be set. What is shown in the example is the use of a shape memory alloy whose length is shorter at a higher temperature than at a low temperature. At room temperature or in a temperature range which can be considered to be room temperature in a motor vehicle, the length of the shape memory alloy in the form of a wire is initially L1. In a motor vehicle, the temperature range concerned can usually be assumed to be between −40° C. and +80°. The shape memory alloy which is used for the wire must be selected accordingly. If the temperature rises above a lower limiting temperature Tmin, the length of the wire begins to shorten. To meet the requirements which apply in a motor vehicle, this lower limiting temperature Tmin should be >90° C. or more preferably >100° C. If the temperature continues its rise above this lower limiting temperature Tmin, then the length of the wire becomes smaller until an upper limiting temperature Tmax is reached from where there is only an insignificant change in the length of the wire. For the energy absorber to be used as an energy absorbing means in the event of a crash, a temperature within the range between and including the limiting temperatures Tmin and Tmax therefore has to be set in the crash. It is however also conceivable and possible simply for the room temperature to be selected as a first temperature and for a defined level of force for the displacement to be set for this temperature when the steering system is being designed in such a way that a first suitable energy absorption and no fixing takes place. Systems of this kind are then generally not suitable to act as fixing arrangements at the same time.

It is shown in FIG. 9 how a suitable temperature T can be set by a flow of current I through the wire. As the current I increases, the temperature T in the wire rises. On a lower limiting current Imin being reached, the lower limiting temperature Tmin is reached in the wire and on an upper limiting current Imax being reached, the corresponding upper limiting temperature Tmax is reached in the wire. If, as taught by the invention, this wire is used in an energy absorber, as a component in a clamping drum 11 for example, the given length at the time produces a corresponding clamping force for clamping the steering shaft mounting unit 3 relative to the bracket unit 2. By suitable design, forces which act as resisting forces against a displacement of the steering shaft mounting unit can be sized at the appropriate levels. If the energy absorber is also used as a fixing arrangement, it must be ensured that an upper limiting force Fmax preset by the vehicle manufacturer equates with the first position of the energy absorber. Upper limiting forces Fmax of this kind are usually in the region of 5,000 or even 10,000 N.

If the energy absorber is also used as a fixing arrangement, the driver has to be easily able to displace the steering shaft mounting unit, or rather the steering wheel 12 fastened to the steering shaft 4, when the energy absorber is in the second position, “easily” meaning that the resisting force is not to exceed a preset lower limiting force Fmin. This force too can be suitably designed as part of the design process, in which case the length of the wire, the number of loops, the distance between the two plates 17, the size of the two plates 17 and other parameters, even parameters of the steering column itself, can be used for the sizing process. It is also conceivable and possible for one, two or even a plurality of clamping drums to be used to enable the parameters called for to be obtained.

It is obvious that these sizings will need to be checked out in appropriate tests.

It is also possible with the energy absorber 8 according to the invention for intermediate values F1, F2 to be set for the resisting force against the displacement of the steering shaft mounting unit. Values of force suitable for different parameters (tall, heavy driver; short, light driver, driver wearing seat belt, driver not wearing seat belt, speed of vehicle, etc.) can be defined in this way and set in the event of a crash. Two levels of force F1 and F2 which can be set by supplying currents 11 and 12 to the wire 6 in the appropriate way are shown as an example in FIG. 15.

As shown in FIGS. 8 and 9, the values of current I1 and I2 equate with corresponding temperatures T1 and T2 and these in turn equate with corresponding lengths L1 and L2 for the wire. This equating makes it possible for the arrangement to be designed easily.

Once the general design of the controllable energy absorber has taken place, its regulating characteristic can be decided on.

FIG. 11 shows by way of example travel vs. time curves for a displacement of the steering shaft mounting unit 3 relative to the bracket unit 2 solidly secured to the bodywork, in the event of a crash. Curve 102 represents in this case a desired curve which should preferably be obtained. The actual curve 103 represents an unregulated curve in a crash where the speed is too high, meaning that there is a peak force at the end of the interval of length Smax. The actual curve 104 represents a crash in which the braking is excessively high in comparison with the ideal curve. The first division of the distance travelled S in this case is a range between S0 at which the crash is detected and S1 which represents the beginning of the displacement of the steering shaft mounting unit relative to the bracket unit. The displacement is limited to a maximum length of displacement Smax and ends there at the displaced position Se. The references Si, Si-1, Si-2 define intermediate values which are in direct succession to one another. To regulate the controllable energy absorber, the instantaneous speed at the given positions is determined in a first version.

Corresponding speed vs. travel graphs such as may occur in different crash situations are shown in FIGS. 12 and 13. In FIG. 12, the positions which occur are Si-2, Si-1 and Si and the respective speeds are Vi-2, Vi-1 and Vi. In this example, the elapsed time until the positions Si-2, Si-1 and Si are reached is measured. The speed at the given Si position is determined from travel and time simply by division. From this, the value of position Sx at which speed will reach a value of zero if the resisting force remains constant is calculated beforehand. As can be seen from FIG. 12, the value Sx is greater than the travel available in the interval Smax. There would thus still be an elevated speed of displacement at the end position Se of the interval, which would suddenly be braked to zero. To deal with this, the control system regulates the value of current such that the resisting force against any further displacement is increased. In the exemplary embodiments explained above, a value of current would, in FIG. 10 for example, be changed from the value I1 to I2 in order to obtain a corresponding increase in the resisting force against the displacement from F1 to F2. The opposite case is shown in FIG. 13. Here, an extrapolation of speed as a function of the position of the steering shaft mounting unit shows speed assuming a value of zero at a value Sx which is situated before the limit Se of the interval. The resisting force can therefore be lowered and the driver can thus be braked in a more “kindly” manner.

FIGS. 14 and 15 show comparable crash curves but where it is positions which are measured at fixed preset points in time ti-2, ti-1, ti. The procedure is similar to that which has been explained by reference to FIGS. 12 and 13.

Shown in FIGS. 16 and 17 are actuating currents for the energy absorption to follow a regulated path. The crash begins at a starting point in time which correlates with a start of travel S0. This may for example be detected by an airbag control unit and transmitted to the control system 23 in the form of the crash signal 9. An increased initial current is advantageously applied to the crash system to make it easier for the steering shaft mounting unit to be released from the position where it is fixed relative to the bracket unit. It should be remembered in this case that the transition from static friction to sliding friction is never a steady one and may result in corresponding peaks of force. A certain amount of time is always required for the wire to heat up. Sufficient resisting force for the airbag to operate reliably may therefore still be available even if the flow of current is switched on immediately. Once the airbag has relaxed its pressure again and the driver impacts on the steering wheel (at position S1), the current is immediately reduced to assist the transition from static friction to sliding friction to some degree. The appropriate measurements are made at the various positions along the travel, which are shown here by way of example as Si-2, Si-1, Si. An assessment of whether the desired curve for speed or acceleration is being obtained with the preset resisting force can be made after at least three measurements have been made. In the case of FIG. 16 it is clear that the resisting force was too high initially and had to be suitably reduced by increasing the flow of current by taking the regulating action at 106. FIG. 16 approximately corresponds, mutatis mutandis, to what is shown in FIGS. 13 and 15.

Shown in FIG. 17 is a case where the resisting force set initially was too low and the driver would arrive at the end of the interval at too high a speed. An increase in the resisting force is therefore set by lowering the flow of current by the regulating action at 106. Should the lowering have been too great, further improvements can be made by regulating actions at further points, which are represented here by the regulating action at 107. FIG. 17 corresponds mutatis mutandis with what is shown in FIGS. 12 and 14.

Shown in FIG. 18 is a curve for a crash which is a plot of the elapsed times ti until the respective positions si are reached. Position S0, which corresponds to time t0, indicates the state before the beginning of the displacement of the steering shaft mounting unit. Immediately on the displacement beginning, the position Sa is left and the time is reset to 0. The corresponding elapsed times t1, t2, t3 . . . , ti-2, ti-1, . . . to are determined at the positions S1, S2, S3 . . . , Si-2, Si-1, Si . . . Se. In a variant of the invention, a curve for the times ti as a function of the positions Si is stored in a table and provision is made for this curve to be obtained by setting the resisting force in a suitable way. The desired curve 102 represents a master curve of this kind. If there is then a displacement of the steering shaft mounting unit relative to the bracket which shows departures from this preset desired curve 102, then the control current is adjusted with a simple proportional controller to give an approximation of the desired curve 102. This is shown by the actual curve 105 along which regulating action is taken at each of the regulating actions 106 and 107, which is reflected in a corresponding change in the path followed by the curve. In this way, a very good approximation of the optimum curve for energy absorption by the steering column in the event of a crash can be obtained by a very simple regulating process.

It is clear that the desired curve 102 can very easily be varied as a function of initial results of measurement. Suitable desired curves can be determined in appropriate crash tests.

The desired curve 102 for the preset speeds vVi, for the preset positions sVi and/or for the preset times tVi is determined when the steering column is being designed. Various scenarios may be postulated for this purpose. In particular, crash tests may be carried out with dummies or calculations may be made in simulations for various parameters such as tall driver, short driver, light driver, heavy driver, driver wearing seat belt, driver not wearing seat belt and for other parameters as desired. Corresponding actual curves are determined by this means. The energy transmitted to the steering shaft mounting unit can be determined from the actual curves. An optimum curve for force to be followed in absorbing each given level of energy can be decided on by taking into account the considerations outlined above. From the optimised curve for force, desired curves can be determined which are matched to the particular parameters. From the initial measured values (position, time, speed), it can then quickly be decided which of the actual curves previously stored is most similar to the curve being followed in the crash happening at the time. The desired curve determined for this actual curve is then selected in the appropriate way as the desired curve 102 for the regulation.

In all the embodiments and variants of the invention, the starting value for the current to be set at the beginning of the crash process may, with advantage, be determined from other parameters if such parameters are known. Such parameters may for example give the following information and/or measured values: whether or not the driver is wearing a seat belt, whether or not there is a belt pretensioner, what seated position the driver is in, how tall the driver is, and what the weight of the driver is. There are also other parameters which are conceivable and possible. The corresponding starting values can be determined when the system is being designed, in a similar way to what was done for the desired curves.

A particular advantage of the method of regulation according to the invention is that no complicated and costly simulation calculations are required to design an optimum crash curve. By measurements which subsume a large number of parameters, the regulation can be performed without an exact knowledge of the parameters, such as friction for example, which occur at the time and can result in optimum energy absorbing behaviour by the steer column.

It is clear that the method according to the invention can also be applied to other controllable energy absorbers. In this way, the mechanism described in GB 2435551 B may also be operated in the manner according to the invention by adding a position measuring system. In this case, a value of current would likewise serve as a control signal. However, because an eddy current is used to generate the resisting force, higher values of current would produce higher resisting forces and lower values of current would produce lower resisting forces. The curves such as are shown in FIG. 10 would therefore have to be plotted afresh and the regulating system adapted to them.

The variety of different exemplary embodiments which have been described shows that the invention may be embodied in many different variant ways, without it being possible for all of the conceivable variants to be described here.

1. A method of regulating a controllable energy absorber in a steering system for a motor vehicle, the method including:
a) determining a parameter of a relative movement between a bracket unit configured to be securely fixed to the motor vehicle and a steering shaft mounting unit, held by the bracket unit and configured for the rotatable mounting of a steering shaft, the steering shaft mounting unit being displaceable relative to the bracket unit along a travel in displacement within a limited interval,
b) outputting a control signal to a controllable energy absorber configured to set a resisting force against a displacement of the steering shaft mounting unit relative to the bracket unit,
c) determining the parameter by means of a sensor for determining a position of the steering shaft mounting unit along the direction of displacement, including calculating an instantaneous speed of relative movement of the steering shaft mounting unit, and
d) determining a preset value for a value of the control signal for output to the energy absorber, based at least in part on an instantaneous position and an instantaneous speed at which the instantaneous relative movement is taking place.

2. The method of regulating a controllable energy absorber according to claim 1, wherein the preset value calculated in a given case for the control signal is altered in the direction of a higher resisting force if the instantaneous speed most recently determined is equal to or greater than an instantaneous speed determined immediately before it, or if the instantaneous speed most recently determined is greater than a preset speed for the given case.

3. The method of regulating a controllable energy absorber according to claim 1, wherein the preset value calculated in a given case for the control signal is altered in the direction of a lower resisting force if the instantaneous speed most recently determined is so much lower than an instantaneous speed determined immediately before it that, if a change in speed continues to be constant, the instantaneous speed will reach a value of zero before a limit of the interval of travel in displacement is reached, or if the instantaneous speed most recently determined is less than a preset speed for the given case.

4. The method of regulating a controllable energy absorber according to claim 1, wherein the preset value calculated in a given case for the control signal is altered in the direction of a higher resisting force if a group of most recently determined values of instantaneous speed is equal to or greater than a group of values of instantaneous speed determined immediately before them.

5. The method of regulating a controllable energy absorber according to claim 4, wherein the preset value calculated in the given case for the control signal is altered in the direction of a lower resisting force if the group of most recently determined values of instantaneous speed is so much lower than the group of instantaneous speeds determined immediately previously that, if a change in instantaneous speed continues to be constant, the instantaneous speed will reach a value of zero before a limit of the interval of travel in displacement is reached.

6. A method of regulating a controllable energy absorber in a steering system for a motor vehicle, the method including:
a) determining a parameter of a relative movement between a bracket unit configured to be securely fixed to the motor vehicle and a steering shaft mounting unit, held by the bracket unit and configured for the rotatable mounting of a steering shaft, the steering shaft mounting unit being displaceable relative to the bracket unit along a travel in displacement within a limited interval,
b) outputting a control signal to a controllable energy absorber configured to set a resisting force against a displacement of the steering shaft mounting unit relative to the bracket unit,
c) determining the parameter by means of a sensor for determining a position of the steering shaft mounting unit along the travel in displacement by:
measuring an instantaneous position of the steering shaft mounting unit, continuously or at presettable points in time, and calculating an instantaneous value in a given case for a desired difference in the form of a difference between the instantaneous position less a preset position for the given case, or
determining elapsed times at presettable positions of the steering shaft mounting unit and calculating an instantaneous value in a given case for a desired difference in the form of a difference given by the preset time less the elapsed time for the given case, and
d) determining a preset value for the value of the control signal for output to the energy absorber on the basis of the instantaneous position and the desired difference.

7. The method according to claim 6, wherein the preset value calculated in the given case for the control signal is altered in the direction of a higher resisting force if the instantaneous value of the desired difference is greater than zero, and the preset value calculated in the given case for the control signal is altered in the direction of a lower resisting force if the instantaneous value of the desired difference is less than zero.

8. The method according to claim 6, further comprising changing the control signal proportionally by applying a proportionality factor.

9. The method according to claim 8, wherein the proportionality factor is varied as the travel in displacement increases.

10. The method according to claim 6, wherein the control signal is only changed if the instantaneous speed exceeds a predefined value at least at a predefined position and/or if a crash has been detected.

11. The method according to claim 6, wherein the value of the control signal is a value of current or a value of voltage and/or wherein a resisting force drops as the value of the control signal increases.

12. An apparatus for regulating a controllable energy absorber in a steering system for a motor vehicle, the steering system having a bracket unit configured to be securely fixed to the motor vehicle and having a steering shaft mounting unit, configured to be held by the bracket unit and for rotatable mounting of a steering shaft, the steering shaft mounting unit being displaceable relative to the bracket unit along a travel in displacement within a limited interval, the energy absorber being suitable for applying a resisting force against a displacement of the steering shaft mounting unit relative to the bracket unit, the energy absorber configured to be set to various resisting forces by a control signal, said apparatus including:
a sensor configured to determine a position of the steering shaft mounting unit along the travel in displacement to enable an instantaneous position of the steering shaft mounting unit to be measured,
a clock generating device comprising either travel markers or a clock generator along the travel in displacement, the clock generating device being configured to trigger measurement of the instantaneous position and execution of one or more calculations,
a computer configured to calculate a preset value for the control signal, and
an output configured to output the control signal to the energy absorber.

13. The method according to claim 9, wherein the proportionality factor is reduced in proportion to the travel in displacement
